(19) United States
(12) Patent Application Publication
(10) Pub. No.: US 2009/0038763 A1
(43) Pub. Date: Feb. 12, 2009

(54) Curtain Structure

(76) Inventor: Shih-Ming Lin, Chiayi City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/834,850

(22) Filed: Aug. 7, 2007

(51) Int. Cl. E06B 9/384

(52) U.S. Cl. 160/179

(57) ABSTRACT

An improved curtain structure comprises a curtain body including a plurality of elongated pieces disposed thereon, a shading member including a plurality of retaining sections and fitting sections formed on the upper and lower ends thereof and having intervals arranged therebetween respectively, since the retaining sections and the fitting sections of the shading member include a plurality of intervals arranged therebetween, and each retaining section includes an opening facing downward, yet each fitting section includes an opening formed thereon, accordingly the retaining sections may be attached onto the upper ends of the elongated pieces directly, and the lower ends of the elongated pieces may be inserted into the fitting sections for a positioning purpose, such that the shading member may be wound in a waved manner along the orderly arranged elongated pieces to couple with the front and back planes of the elongated pieces, thus assembling and disassembling the entire related components easily.

### BACKGROUND OF THE INVENTION

1. Field of the Invention

The present invention relates to a curtain, and more particularly to an improved curtain structure that may assemble and disassemble the entire related components thereof easily.

2. Description of the Prior Arts

Convention curtain includes a plurality of elongated pieces provided in a transmitting structure of a rail and independent from each other for being expanded or extracted, and by using an angular rotating design, the curtain may selectively shade sunshine.

Due to the elongated pieces of the conventional curtain are independent from each other, during the expansion of the elongated pieces, the elongated pieces bring about interspaces therebetween, hence sunshine may not be completed shaded. To overcome such a problem, an improved curtain has been developed. The improved curtain includes a shading member disposed thereon for having better shading effect. However, in assembly, the elongated pieces have to be fixed by using a number of clamping members individually, enhancing assembled difficulty and production cost.

The present invention has arisen to mitigate and/or obviate the afore-described disadvantages.

### SUMMARY OF THE INVENTION

The primary object of the present invention is to provide an improved curtain structure that may assemble and disassemble the entire related components thereof easily.

Another object of the present invention is to provide an improved curtain structure that may lower the production cost.

In accordance with one aspect of the present invention, there is provided an improved curtain structure comprising a curtain body and a shading member. The curtain body includes a plurality of elongated pieces disposed thereon. The shading member includes a plurality of retaining sections and fitting sections formed on the upper and lower ends thereof and having intervals arranged therebetween respectively, for fixing the elongated pieces of the curtain body thereto, such that the retaining sections of the shading member allow to be retained onto the upper end of the curtain body, and the fitting sections of the shading member may provide to receive the lower ends of the elongated pieces so as to assemble the shading member and the curtain body together for expanding or extracting the curtain.

Since the retaining sections and the fitting sections of the shading member include a plurality of intervals arranged therebetween, and each retaining section includes an opening facing downward, yet each fitting section includes an opening formed thereon, accordingly the retaining sections may be attached onto the upper ends of the elongated pieces directly (the shading member and the elongated pieces may be combined as a whole by using a transmitting structure provided in a rail), and the lower ends of the elongated pieces may be inserted into the fitting sections for a positioning purpose, such that the shading member may be wound in a waved manner along the orderly arranged elongated pieces to couple with the front and back planes of the elongated pieces, thus assembling and disassembling the entire related components easily.

Preferably, at a predetermined position of the side of the shading member 2 associated with the outermost elongated piece is provided with a coverable folding segment, for combining the retaining section and the fitting section of the outermost elongated piece together, such that the folding segment permits to cover the outermost elongated piece around.

Also, the folding segment may cover the outermost elongated piece around by way of a magic pad.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the exploded components of an improved curtain structure according to the present invention;

FIG. 2 is a perspective diagram illustrating elongated pieces of a curtain body and a shading member being assembled together;

FIG. 3 is a perspective diagram illustrating the assembly of the improved curtain structure according to the present invention;

FIG. 4 is a perspective diagram illustrating the operation of the improved curtain structure according to the present invention.

### DETAILED DESCRIPTION OF THE PREFERRED EMBODIMENT

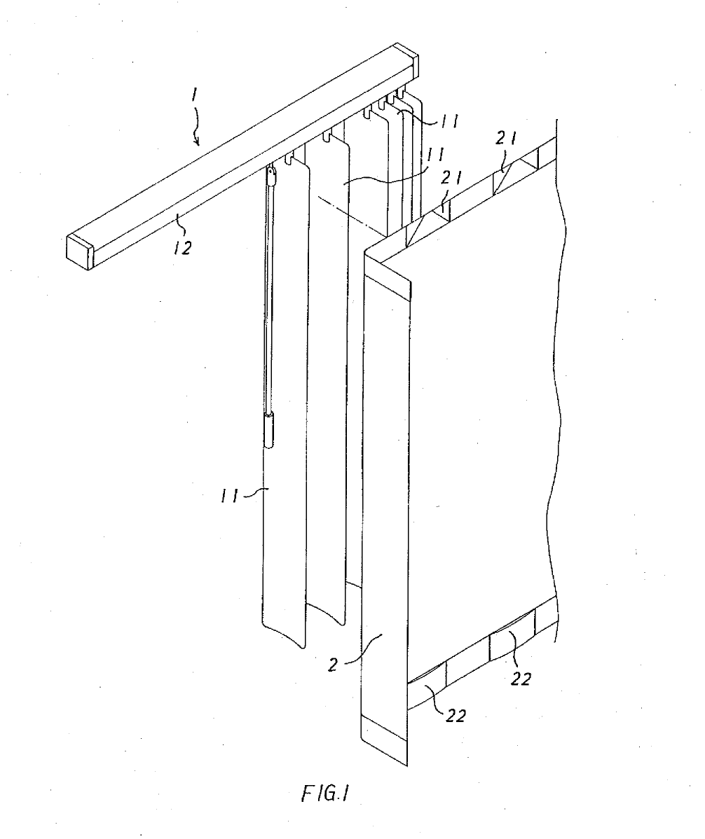

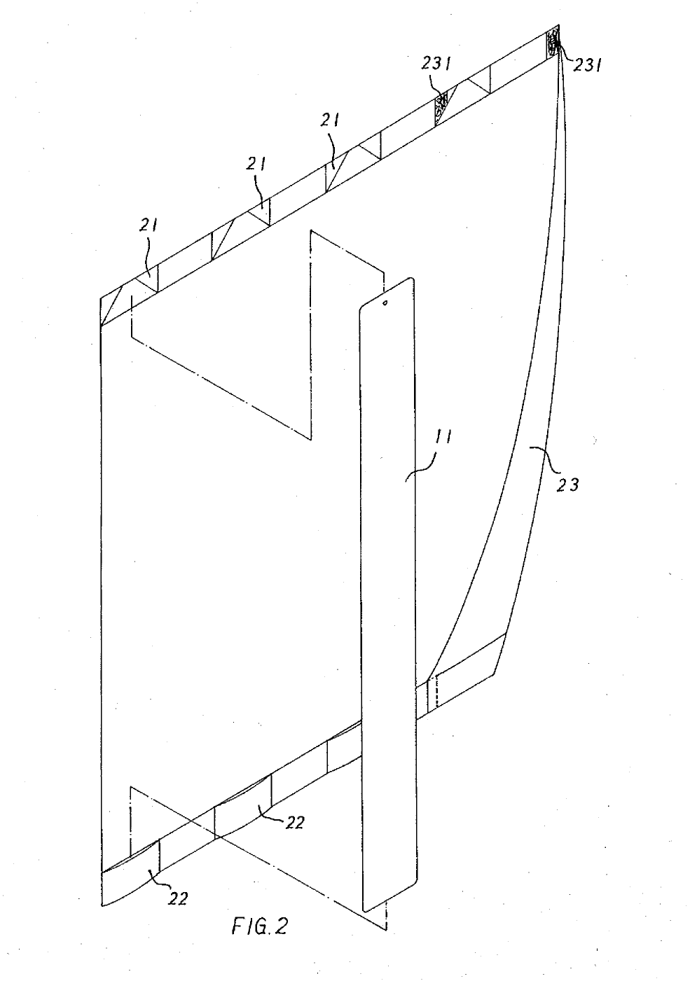

An improved curtain structure in accordance with the present invention comprises a curtain body I and a shading member 2 (as shown in FIG. 1). The curtain body 1 includes a plurality of elongated pieces 11 disposed thereon. The shading member 2 includes a plurality of retaining sections 21 and fitting sections 22 formed on the upper and lower ends thereof and having intervals arranged therebetween respectively, for fixing the elongated pieces 11 of the curtain body 1 thereto, such that the retaining sections 21 of the shading member 2 allow to be retained onto the upper end of the curtain body 1 (as illustrated in FIG. 2), and the fitting sections 22 of the shading member 2 may provide to receive the lower ends of the elongated pieces 11 so as to assemble the shading member 2 and the curtain body 1 together for expanding or extracting the curtain.

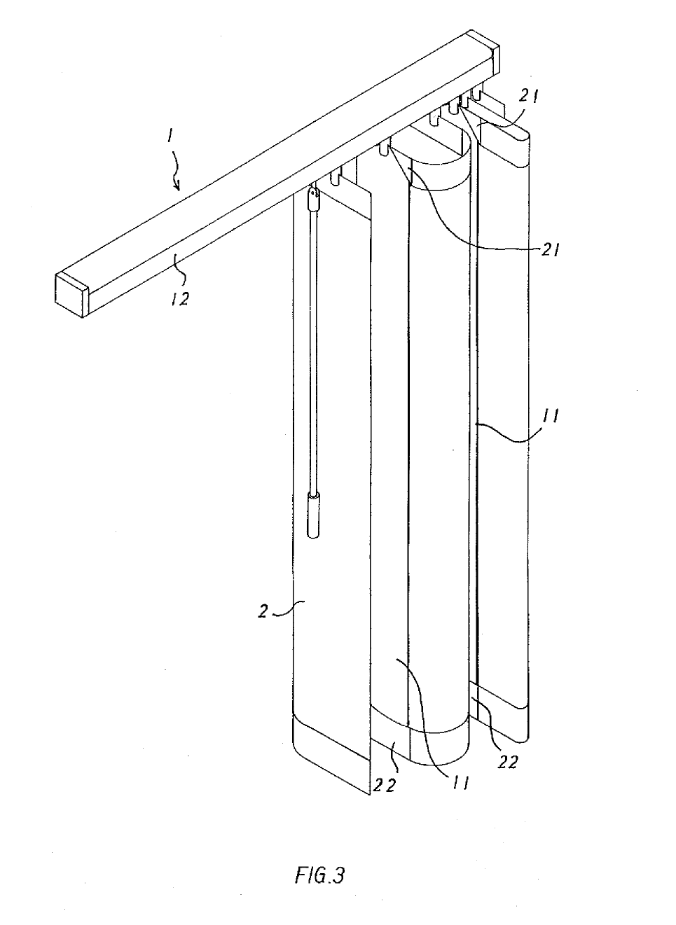

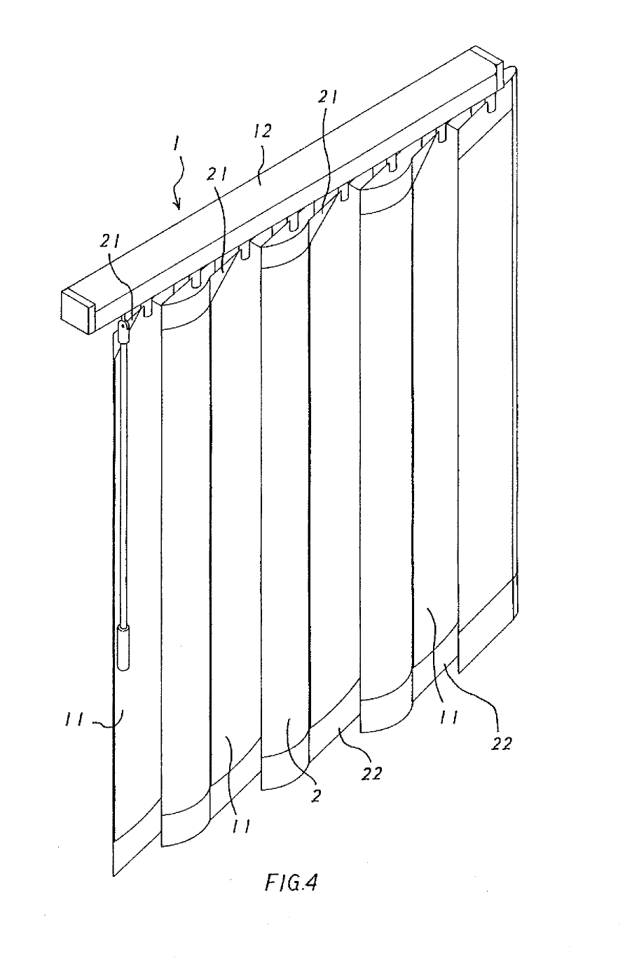

Since the retaining sections 21 and the fitting sections 22 of the shading member 2 include a plurality of intervals arranged therebetween, and each retaining section 21 includes an opening facing downward, yet each fitting section 22 includes an opening formed thereon, accordingly the retaining sections 21 may be attached onto the upper ends of the elongated pieces 11 directly (the shading member 2 and the elongated pieces 11 may be combined as a whole by using a transmitting structure provided in a rail 12), and the lower ends of the elongated pieces 11 may be inserted into the fitting sections 22 for a positioning purpose, such that the shading member 2 may be wound in a waved manner along the orderly arranged elongated pieces 11 to couple with the front and back planes of the elongated pieces 11 (as shown in FIGS. 3 and 4), thus assembling and disassembling the entire related components easily.

Preferably, at a predetermined position of the side of the shading member 2 associated with the outermost elongated piece 11 is provided with a coverable folding segment 23 (as illustrated in FIG. 2), for combining the retaining section 21 and the fitting section 22 of the outermost elongated piece 11 together, such that the folding segment 23 permits to cover the outermost elongated piece 11 around.

Also, the folding segment 23 may cover the outermost elongated piece 11 around by way of a magic pad 231.

The invention is not limited to the above embodiment but various modifications thereof may be made. It will be understood by those skilled in the art that various changes in form and detail may made without departing from the scope and spirit of the present invention.

What is claimed is:

1. An improved curtain structure comprising:
a curtain body and a shading member, wherein said curtain body includes a plurality of elongated pieces disposed thereon, and said shading member includes a plurality of retaining sections and fitting sections formed on the upper and lower ends thereof and having intervals arranged therebetween respectively, since said retaining sections and said fitting sections of said shading member include a plurality of intervals arranged therebetween, and each retaining section includes an opening facing downward, yet each fitting section includes an opening formed thereon, accordingly said retaining sections may be attached onto the upper ends of said elongated pieces directly, and the lower ends of said elongated pieces may be inserted into said fitting sections for a positioning purpose, such that said shading member may be wound in a waved manner along the orderly arranged elongated pieces to couple with the front and back planes of said elongated pieces, thus assembling and disassembling the entire related components easily.

2. The improved curtain structure as claimed in claim 1, wherein at a predetermined position of the side of said shading member associated with the outermost elongated piece is provided with a coverable folding segment, for combining said retaining section and said fitting section of the outermost elongated piece together, such that said folding segment permits to cover the outermost elongated piece around.

3. The improved curtain structure as claimed in claim 2, wherein said folding segment may cover said outermost elongated piece around by way of a magic pad.
